(19) United States
(12) Patent Application Publication
(10) Pub. No.: US 2014/0132935 A1
(43) Pub. Date: May 15, 2014

(54) PROJECTION APPARATUS

(71) Applicant: Samsung Electronics Co., Ltd., Suwon-si (KR)

(72) Inventors: Hak-young KIM, Yongin-si (KR); Jun-seok PARK, Suwon-si (KR); Sung-tae KIM, Seoul (KR); Jeong-ho NHO, Suwon-si (KR); Jean HUR, Seongnam-si (KR)

(21) Appl. No.: 13/915,840

(22) Filed: Jun. 12, 2013

(30) Foreign Application Priority Data
Nov. 14, 2012 (KR) 10-2012-0128881

(51) Int. Cl. G03B 21/10

(52) U.S. Cl. CPC G03B 21/10
USPC 353/79

(57) ABSTRACT

A projection apparatus includes an image projection unit configured to form an image and project the formed image, a screen unit configured to display the image projected from the image projection unit, and a mounting unit on which the image projection unit and the screen unit are integrally mounted. The screen unit is formed to have a curvature.

### CROSS-REFERENCE TO RELATED APPLICATION

This application claims priority from Korean Patent Application No. 10-2012-0128881, filed on Nov. 14, 2012, in the Korean Intellectual Property Office, the disclosure of which is incorporated herein by reference in its entirety.

### BACKGROUND

1. Field

Apparatuses consistent with exemplary embodiments relate to a projection apparatus, and more particularly, to a projection apparatus including an integrated image projection unit and screen unit.

2. Description of the Related Art

In general, projection apparatuses include an image projection unit configured to project an image and a screen configured to display the projected image, which are separated from each other. When the image projection unit is separated from the screen, the screen is fixed to a frame and hung on the wall or fixed to additional storage furniture and the image projection unit is disposed in additional storage furniture in front of the screen. In the projection apparatus in the related art, a structure such as a plate attached to the screen is mounted to prevent the screen from being bent.

Since there is no connection structure configured to control a position between the image projection unit and the screen in the projection apparatus of the related art, in which the image projection unit is separated from the screen, the screen adjustment is performed in advance whenever the projection apparatus is driven.

In the projection apparatus of the related art, since the image projection unit is separated from the screen, the projection apparatus cannot give a user an awareness in which the image projection unit and the screen are one set.

Further, to implement three-dimensional (3D) stereoscopic effect, an additional method such as an optical method using multi-lenses or a circuit driving method has to be applied to the projection apparatus in the related art and thus it is disadvantageous in terms of cost.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments are to provide a projection apparatus which includes an integrated image projection unit and screen unit and implements a 3D stereoscopic effect.

According to an aspect of an exemplary embodiment, there is provided a projection apparatus. The projection apparatus may include: an image projector configured to form an image and extend and project the formed image; a screen unit configured to display the image projected from the image projector; and a mounting unit on which the image projector and the screen unit are mounted. The screen unit may be formed to have a curvature.

The screen unit may include a screen configured to display the image and a screen attaching part to which the screen is attached and which is formed to be concavely curved at a side thereof to which the screen is attached.

The screen may be attached to the screen attaching part via lamination.

The screen attaching part may include a front plate to which the screen is attached; a rear plate disposed in a rear of the front plate; and a strength reinforcing member disposed between the front plate and the rear plate.

The strength reinforcing member may have a honeycomb shape.

The strength reinforcing member may have a wave shape.

The strength reinforcing member may be formed so that a plurality of grooves are continuously formed to be spaced apart from each other at least one from among horizontally and vertically.

The screen unit may further include at least one curvature adjuster disposed in rear of the screen unit and configured to adjust the curvature of the screen unit.

The curvature adjuster may be included in pairs and the pair of curvature adjusters may be disposed to be spaced apart from each other in a vertical direction of the rear plate.

The curvature adjuster may include at least one protrusion formed to protrude from the rear plate, a supporting plate formed along a length direction of the rear plate and disposed to face the at least one protrusion, and at least one fastener configured to pass through the supporting plate and be fastened to the at least one protrusion so that the at least one protrusion moves in a forward and backward direction.

The protrusion may be included in pairs and the pair of protrusions may be disposed to be spaced apart from each other in the length direction of the rear plate.

At least one protrusion and the at least one fastener may be screw-combined.

The supporting plate may include a vertical portion which faces the protrusion and in which at least one through hole, through which the at least one fastener passes, is formed, a first horizontal portion extending from an end of the vertical portion, and a second horizontal portion extending from the other end of the vertical portion.

The vertical portion may be formed so that a central portion of a side surface of the vertical portion facing a rear surface of the rear plate may be in contact with the rear surface of the rear plate.

The curvature adjustment unit may be mounted on the mounting unit.

The mounting unit may include a base frame, a mounting bracket provided inside the base frame and on which the image projector and the screen unit are mounted, and a cover frame which covers the base frame.

The mounting bracket may include at least mounting part mounted on the curvature adjuster.

The second horizontal portion may include at least one mounting groove via which at least one mounting part is mounted.

The cover frame may include a cover glass through which the image projected from the image projector passes.

The image projector and the screen unit may be integrally mounted.

According to the above-described exemplary embodiments, a projection apparatus, which includes an integrated image projection unit and screen unit and implements a 3D stereoscopic image effect, may be provided.

Additional aspects and advantages of the exemplary embodiments will be set forth in the detailed description, will be obvious from the detailed description, or may be learned by practicing the exemplary embodiments.

### BRIEF DESCRIPTION OF THE DRAWING FIGURES

The above and/or other aspects will be more apparent by describing in detail exemplary embodiments, with reference to the accompanying drawings, in which:

FIG. 1 is a perspective view illustrating a projection apparatus according to an exemplary embodiment;

FIG. 2 is a cross-sectional view illustrating the projection apparatus of FIG. 1;

FIG. 3 is an exploded perspective view illustrating a screen unit provided in the projection apparatus of FIG. 1;

FIG. 4 is an exploded perspective view illustrating a screen attaching part provided in the screen unit of FIG. 3;

FIG. 5 is a perspective view illustrating a strength reinforcing member provided in the screen attaching part of FIG. 4 according to an alternative exemplary embodiment;

FIG. 6 is a perspective view illustrating a strength reinforcing member provided in the screen attaching part of FIG. 4 according to another alternative exemplary embodiment;

FIG. 7 is a front perspective view illustrating a mounting bracket on which the screen unit of FIG. 3 is mounted;

FIG. 8 is a rear perspective view illustrating a mounting bracket on which the screen unit of FIG. 3 is mounted;

FIGS. 9 and 10 are views illustrating a curvature adjustment unit provided in the screen unit of FIG. 3;

FIG. 11 is a view illustrating mounting of a curvature adjustment unit on the screen unit of FIGS. 3; and

FIGS. 12 and 13 are views illustrating curvature adjustment of the screen unit through the curvature adjustment unit of FIG. 11.

### DETAILED DESCRIPTION OF THE EXEMPLARY EMBODIMENTS

Hereinafter, exemplary embodiments will be described in more detail with reference to the accompanying drawings.

In the following description, same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

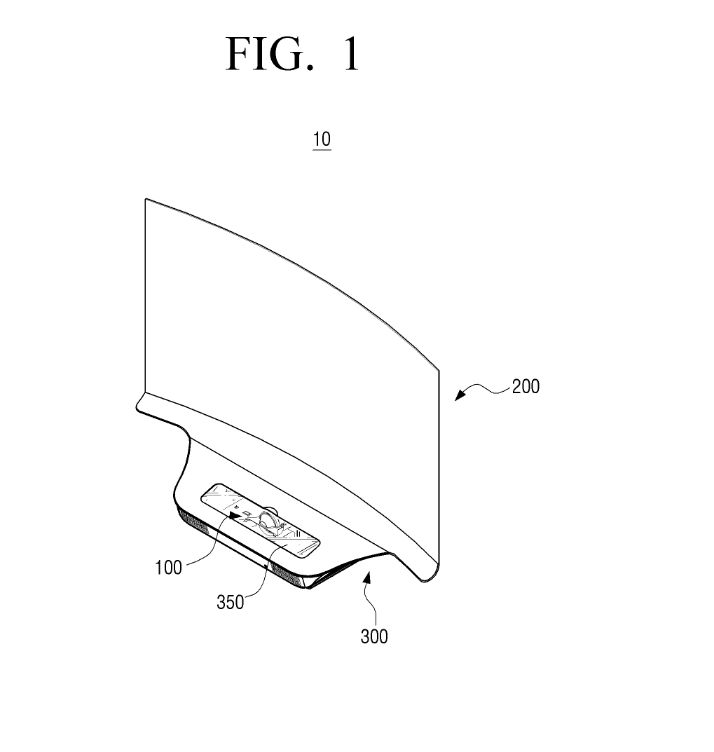

FIG. 1 is a perspective view illustrating a projection apparatus according to an exemplary embodiment.

A projection apparatus 10 includes an image projection unit 100, a screen unit 200, and a mounting unit 300.

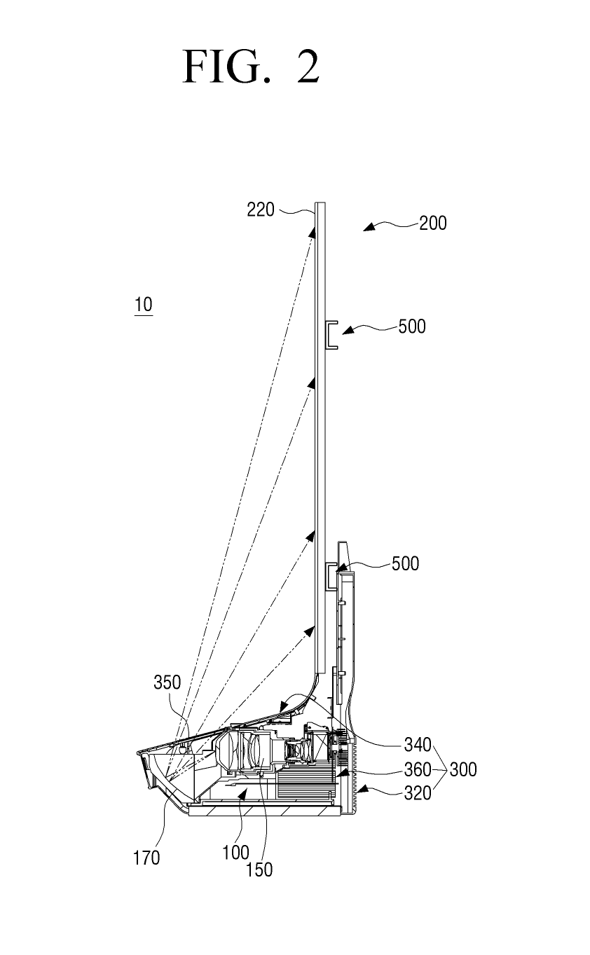

The image projection unit 100 includes an optical system configured to form, extend, and project an image. The image projection unit 100 will be described in more detail with reference to FIG. 2 later.

The screen unit 200 displays the image projected from the image projection unit 100. The screen unit 200 may be integrally mounted with the image projection unit 100 on the projection apparatus 10. The screen unit 200 is formed to have a curvature. That is, the screen unit 200 becomes a curved screen.

The projection apparatus 10 according to the exemplary embodiment may provide an image having a 3D cubic effect such as a 3D stereoscopic effect to a user through implementation of the curved screen without addition of a separate mechanism configured to additionally implement 3D stereoscopic effect. The curved screen enables differentiated cubic image representation through a physical depth and a distance to eyes of the user from an entire region of a screen is uniform so that the curved screen enables the user to conveniently watch the image.

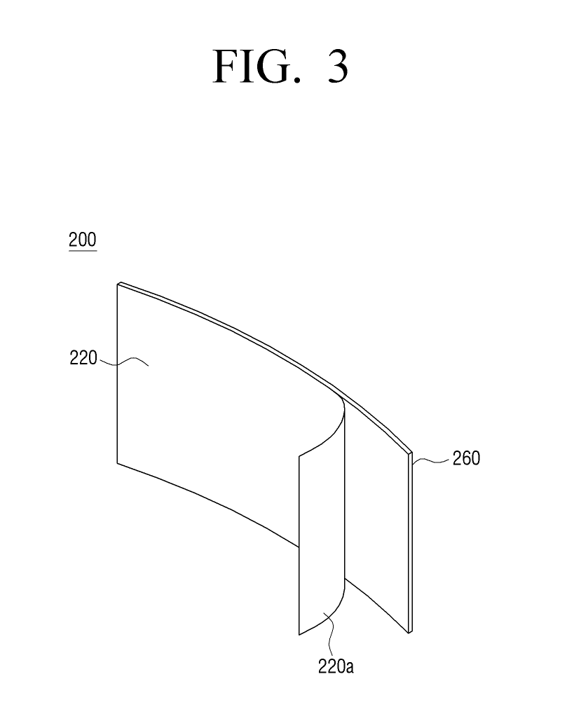

The screen unit 200 will be described in detail with reference to FIGS. 3 to 6 later.

The mounting unit 300 forms an exterior appearance of the projection apparatus 10 and the image projection unit 100 and the screen unit 200 are mounted on the mounting unit 300. The projection apparatus 10 according to the exemplary embodiment may give the user an awareness in which the projection apparatus 10 is one set since the image processing unit 100 and the screen unit 200 are mounted together inside one mounting unit 300.

A cover glass 350 through which the image projected from the image projection unit 100 may pass is provided in the mounting unit 300. The cover glass 350 may be formed of a transparent material and prevent foreign materials such as dust from getting in the image projection unit 100.

Various types of circuit boards (not shown) configured to drive or control the image projection unit and a cooling system (not shown) configured to cool internal parts are further mounted on the mounting unit 300.

FIG. 2 is a cross-sectional view illustrating the projection apparatus of FIG. 1.

Referring to FIG. 2, as described above, the image projection unit 100 includes the optical system. The optical system includes a lighting unit (not shown), an image forming unit (not shown), a projection lens unit 150, and an aspheric mirror 170.

The light unit generates light to be used for forming the image. The lighting unit includes a red (R) light emitting device (LED), a blue (B) LED, and a green (G) LED configured to generate R light, B light, and G light, respectively, as a light source.

In the above-described exemplary embodiment, the lighting unit includes three LEDs as a light source. However, in alternative exemplary embodiments, the lighting unit may include other types of light sources such as a lamp (for example, an arc lamp, a halogen lamp, and the like) configured to generate white light.

The image forming unit includes a digital micro-mirror device (DMD) panel. The DMD panel includes a large number of micro-mirrors and each of the micro-mirrors corresponds to each of image pixels. An image is formed from the light generated by the lighting unit through an on-off operation of the micro-mirrors according to image signals. The image projection unit includes at least one reflection mirror (not shown) configured to reflect the white light generated by the lighting unit to the image forming unit.

The projection lens unit 150 extends and projects the image formed by the image forming unit toward the aspheric mirror 170. A plurality of projection lenses (not shown) configured to extend the image are provided in the projection lens unit 150.

The aspheric mirror 170 displays the image extended and projected by the projection lens unit 150 on the screen unit 200 through the cover glass 350 provided in a cover frame 340. Since the image projection unit 100 in the exemplary embodiment displays the image through the aspheric mirror 170, a distance between the image projection unit 100 and the screen unit 200 may be closer as compared to other cases.

Therefore, in the projection apparatus 10 according to the exemplary embodiment, the image projection unit 100 and the screen unit 200 are disposed close to each other in the mounting unit 300 to obtain the slim apparatus.

The mounting unit 300 includes a base frame 320, the cover frame 340, and a mounting bracket 360.

The base frame 320 contains the mounting bracket 360 and is coupled with the cover frame 340 to form an exterior appearance of the projection apparatus 10. An exterior appearance of the base frame 320 may be suitably changed according to shapes or sizes of the image projection unit 100 and the screen unit 200.

The cover frame 340 covers the base frame 320 and forms a portion of the exterior appearance of the projection apparatus 10 together with the base frame 320. The cover frame 340 includes the above-described cover glass 350 to project the image from the image projection unit 100 to the screen unit 200.

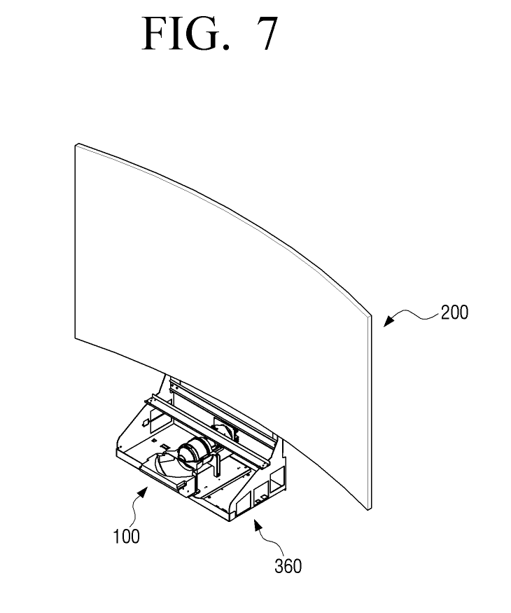

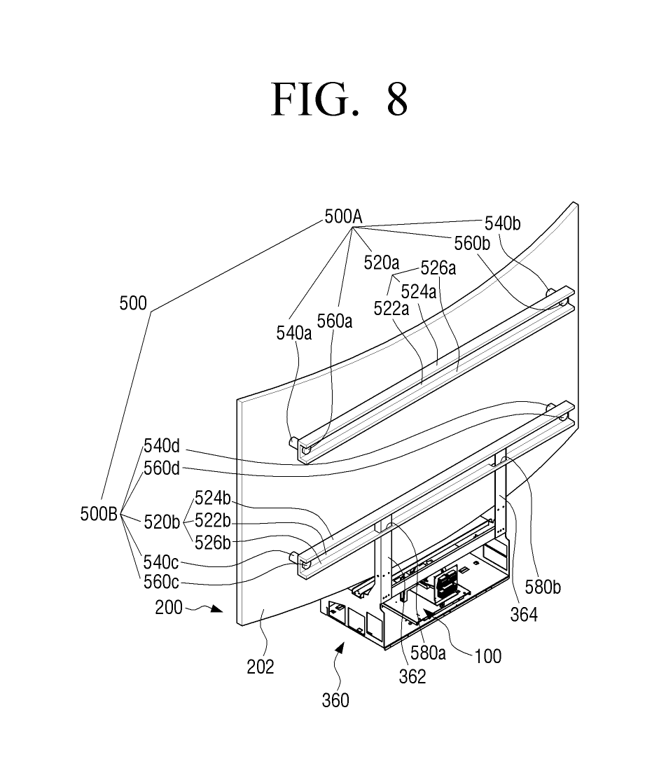

The mounting bracket 360 is mounted on the base frame 320. The image projection unit 100 and the screen unit 200 are mounted on the mounting bracket 360 so that the image projection unit 100 and the screen unit 200 are integrally formed in the projection apparatus 10. Further, a curvature adjustment unit 500 is also mounted on the mounting bracket 360. The mounting bracket 360 will be described in detail with reference to FIGS. 7 and 8 later. The curvature adjustment unit 500 will be described in detail with reference to FIGS. 8 to 13 later.

All the base frame 320, cover frame 340, and mounting bracket 360 may be fabricated of Zn-coated carbon steel plate (SECC). The material for the base frame 320, cover frame 340, and mounting bracket 360 may be suitably changed according to the design thereof.

FIG. 3 is an exploded perspective view illustrating the screen unit provided in the projection apparatus of FIG. 1.

Referring to FIG. 3, the screen unit 200 includes a screen 220 and a screen attaching part 260.

The screen 220 displays an image to the outside and the user can watch the desired image through the screen 220. The screen 220 may be fabricated of fiber glass, a polyethylene (PE) film, and the like.

The screen attaching part 260 is attached to a rear surface 220a of the screen 220 to support the screen 220. The screen attaching part 260 supports the screen 220 and prevents one surface of the screen 220 from being bent. The bending of the screen 220 may cause the image displayed through the screen 220 to be distorted. In the projection apparatus 10 according to the exemplary embodiment, the screen 220 is attached to the screen attaching part 260 to be in contact with and to be support by the screen attaching part 260 so that the bending of the screen is not caused.

The screen attaching part 260 is formed to have a curvature and the screen attaching part is formed to be concavely curved in a horizontal direction. However, it is not limited thereto and the screen attaching part 260 is formed to be concavely curved in a vertical direction. Further, the screen attaching part may be formed to be concavely curved in the horizontal direction as well as in the vertical direction. In this case, when the screen is attached to the screen attaching part, the screen has a spherical surface and thus, the immersion of the user for the image can be more increased.

Here, the screen 220 may be attached to the screen attaching part 260 through a contact method and a laminating method may be used as the contact method. However, the contact method is not limited thereto and the screen 220 may be attached using other methods in which the screen 220 is in contact with the screen attaching part 260 and supported by the screen attaching part 260.

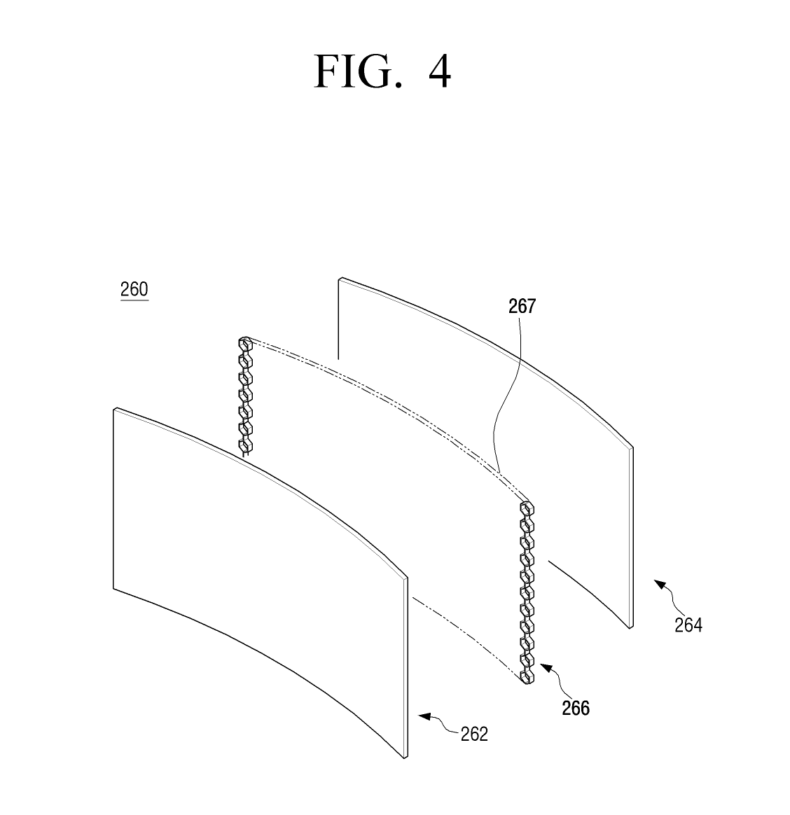

FIG. 4 is an exploded perspective view illustrating the screen attaching part provided in the screen unit of FIG. 3.

Referring to FIG. 4, the screen attaching part 260 includes a front plate 262, a rear plate 264, and a strength reinforcing member 266.

The front plate 262 and the rear plate 264 are coupled and mounted so that the strength reinforcing member 266 is disposed therebetween.

Both the front plate 262 and the rear plate 264 are formed to be concavely curved in the horizontal direction to implement a curved screen.

The strength reinforcing member 266 reinforces strength of the screen attaching part 260 without increase in a thickness of the screen attaching part 260.

The strength reinforcing member 266 is disposed between the front plate 262 and the rear plate 264 and the strength reinforcing member 266 is formed to be concavely curved in the horizontal direction like the front plate 262 and the rear plate 264.

The strength reinforcing member 266 may be attached to the front plate 262 and the rear plate 264, for example, by an adhesive such as a hot melt adhesive. The strength reinforcing member 266 may include a plurality of cells 267 and each of the plurality of cells 267 may have a hexagonal pillar shape.

Therefore, the strength reinforcing member 266 has a honeycomb shape as a whole. Alternative exemplary embodiments, the cell 267 may be changed in various types of shapes, for example, other pillar shapes (for example, a square pillar shape), a cylindrical shape, or the like.

The strength reinforcing member 266 is fabricated of high-strength aluminum (Al). However, the material for the strength reinforcing member 266 is not limited thereto and the strength reinforcing member 266 may be fabricated of other metal materials or non-metal materials (for example, plastic).

In addition to the strength reinforcing member 266, the front plate 262 and the rear plate 264 constituting the screen attaching part 260 are also fabricated of high-strength aluminum (Al). However, the material for the front plate 262 and the rear plate 264 is not limited thereto and the front plate 262 and the rear plate 264 may be fabricated of other metal materials or non-metal materials (for example, plastic).

The strength reinforcing member 266 having the honeycomb shape is mounted between the front plate 262 and the rear plate 264 of the screen attaching part 260 to reinforce the strength of the screen attaching part 260.

The strength reinforcing member 266 having the honeycomb shape may cause the thickness of the screen attaching part 260 to be reduced and therefore cause a bezel in the screen unit 200 to be thinner in a thickness and the screen unit 200 to be lighter in a total weight.

The projection apparatus 10 according to the exemplary embodiment can implement a product, which is lightweight and slim, through the thin bezel of the screen unit 200.

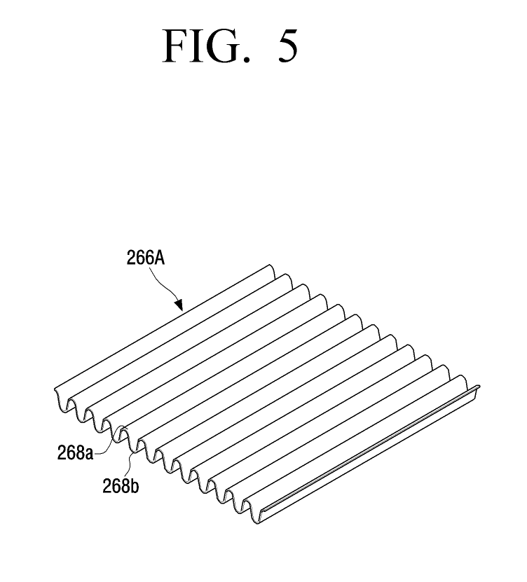

FIG. 5 is a perspective view schematically illustrating a strength reinforcing member provided in the screen attaching part of FIG. 4 according to an alternative exemplary embodiment.

Referring to FIG. 5, an alternative strength reinforcing 266A has a wave shape. Specifically, the strength reinforcing member 266A has a structure in which a convex portion 268a and a concave portion 268b are alternately repeated. Here, the convex portion 268a and the concave portion 268b extend along a width direction or length direction of the strength reinforcing member 266A. That is, one concave portion 268b is arranged between two convex portions 268a and one convex portion 268a is arranged between two concave portions 268b. Further, the strength reinforcing member 266A is formed to be concavely curved in the horizontal direction so that the strength reinforcing member 266A is disposed between the front plate 262 and the rear plate 264 of FIG. 4.

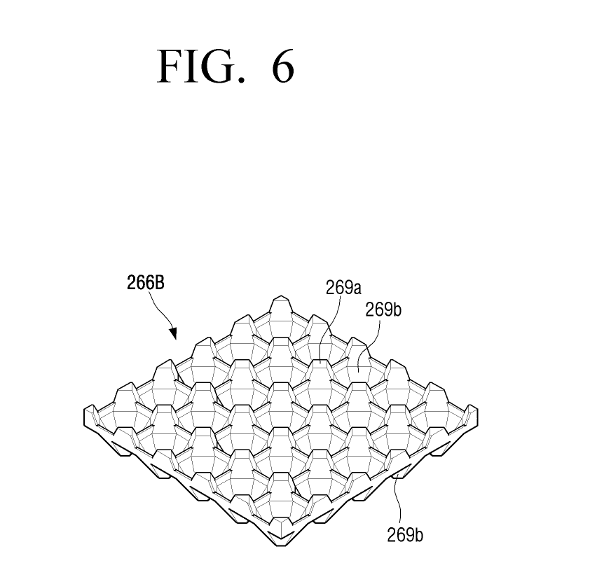

FIG. 6 is a perspective view schematically illustrating a strength reinforcing member provided in the screen attaching part of FIG. 4 according to another alternative exemplary embodiment.

Referring to FIG. 6, another alternative strength reinforcing member 266B has an egg plate. Specifically, the strength reinforcing member 266B includes a plurality of convex portion 269a and a plurality of concave portion 269b which are regularly repeated and has a structure in which one concave portion 269b are arranged among four convex portions 269a and one convex portion 269a are arranged among four concave portions 269b. Further, the strength reinforcing member 266B is formed to be concavely curved in the horizontal direction so that the strength reinforcing member 266B is disposed between the front plate 262 and the rear plate 264 of FIG. 4 like the strength reinforcing member 266A of FIG. 5.

In the exemplary embodiments, only three types of strength reinforcing members 266, 268A, and 268B having different shapes from each other have been illustrated, but other shapes of strength reinforcing members, which can contribute to improve the strength and lighter-weight of the screen unit 200, may be applicable to the inventive concept.

FIG. 7 is a front perspective view illustrating a mounting bracket on which the screen unit is mounted of FIG. 3 and FIG. 8 is a rear perspective view illustrating a mounting bracket on which the screen unit is mounted of FIG. 3.

Referring to FIG. 7, the image projection unit 100 and the screen unit 200 are mounted on the mounting bracket 360. Specifically, the mounting bracket 360 places and fixes the image projection unit 100 in and to a lower portion thereof and fixes the screen unit 200 to an upper portion thereof.

Referring to FIG. 8, a curvature adjustment unit 500 is disposed on a rear surface 202 of the screen unit 200.

The curvature adjustment unit 500 includes a first curvature adjustment unit 500A and a second curvature adjustment unit 500B.

The curvature adjustment unit 500 is configured to adjust a curvature of the screen unit 200 and disposed on a rear of the screen unit 200. A plurality of curvature adjustment unit 500 may be provided and the exemplary embodiment will be described on the assumption that a pair of curvature adjustment units are provided. That is, in the exemplary embodiment, the curvature adjustment unit 500 includes two curvature adjustment units, for example, the first curvature adjustment unit 500A and the second curvature adjustment unit 500B as described above.

The first curvature adjustment unit 500A includes protrusions 540a and 540b, a supporting plate 520a, and fasteners 560a and 560b.

The protrusions 540a and 540b include a first protrusion 540a and a second protrusion 540b. That is, in the exemplary embodiment, the number of protrusions 540a and 540b of the first curvature adjustment unit 500A is two. However, the number of protrusions is not limited thereto and one protrusion may be provided or three or more protrusions may be provided.

The first protrusion 540a is formed to protrude from the rear surface 202 of the screen unit 200, that is, the rear plate (264 of FIG. 4). The first protrusion 540a is formed to protrude near an upper edge in the rear surface 202 of the screen unit 200. In the exemplary embodiment, the first protrusion 540a is formed in an upper left edge of the rear surface 202 of the screen unit 200.

The first protrusion 540a has a boss shape and has a hollow shape so that a first fastener 560a to be described later is fastened to the first protrusion 540a and a screw thread is formed in the inside of the first protrusion 540a so that the first fastener 560a to be described later is fastened to the first protrusion 540a.

The second protrusion 540b is formed to protrude from the rear surface 202 of the screen unit 200 and to be spaced apart from the first protrusion 540a along a length direction of the screen unit 200. The second protrusion 540b has the same vertical height as that of the first protrusion 540a. In the exemplary embodiment, the second protrusion 540b is formed in an upper right edge of the rear surface 202 of the screen unit 200.

The second protrusion 540b has a boss shape like the first protrusion 540a and has a hollow shape so that a second fastener 560b to be described later is fastened to the second protrusion 540b and a screw thread is formed in the inside of the second protrusion 540b so that the second fastener 560b to be described later is fastened to the second protrusion 540b.

The first protrusion 540a and the second protrusion 540b are formed as separate members and mounted on the rear surface 202 of the screen unit 200 in a welding manner so that the first protrusion 540a and the second protrusion 540b are fixed to the rear surface 202 of the screen unit 200. Further, the first protrusion 540a and the second protrusion 540b may be integrally formed with the rear surface 202 of the screen unit 200, that is, the rear plate (264 of FIG. 4) to protrude from the rear plate.

The supporting plate 520a is formed to extend along the length direction of the screen unit 200 and includes a vertical portion 522a, a first horizontal portion 524a, and a second horizontal portion 526a.

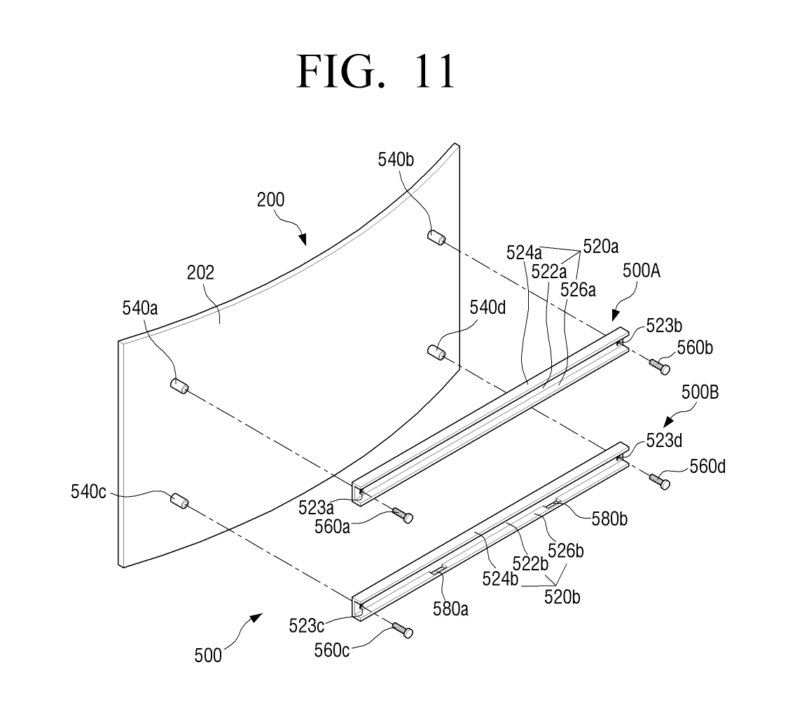

The vertical portion 522a is disposed in a direction in which the first protrusion 540a and the second protrusion 540b face each other. A first through hole (523a of FIG. 11) and a second through hole (523b of FIG. 11), through which the first fastener 560a and the second fastener 560b to be described later, respectively, are formed in the vertical portion 522a.

The first horizontal portion 524a extends from one end of the vertical portion 522a and the second horizontal portion 526a extends from the other end of the vertical portion 522a. The first horizontal portion 524a and the second horizontal portion 526b are arranged parallel to each other along the length direction of the screen unit 200.

The fasteners 560a and 560b are referred to herein as a first fastener 560a and a second fastener 560b, respectively. That is, in the exemplary embodiment, the number of fasteners 560a and 560b of the first curvature adjustment unit 500A is two. However, the number of fasteners is not limited thereto and one fastener may be provided or three or more fasteners may be provided.

The first fastener 560a and the second fastener 560b are screw-combined with the first protrusion 540a and the second first protrusion 540b, respectively. The first fastener 560a and the second fastener 560b may be rotated in a clockwise direction or in a counterclockwise direction, respectively to cause the first protrusion 540a and the second protrusion 540b to move in a forward and backward direction.

Thus, both upper edges of the screen unit 200 fixed to the first protrusion 540a and the second protrusion 540b may move in the forward and backward direction. A moving operation of the screen unit 200 in the forward and backward direction will be described in detail with reference to the accompany drawings.

The second curvature adjustment unit 500B is disposed to a lower portion of the rear surface 202 of the screen unit 200 to be spaced apart from the first curvature adjustment unit 500A. Here, the second curvature adjustment unit 500B is disposed parallel to the first curvature adjustment unit 500A in a vertical direction of the screen unit 200.

The second curvature adjustment unit 500B includes protrusions 540c and 540d, a supporting plate 520b, and fasteners 560c and 560d like the first curvature adjustment unit 500A. The second curvature adjustment unit 500B is similar to the first curvature adjustment unit 500A and hereinafter, description for the second curvature adjustment unit 500B will be made by focusing on differences between the second curvature adjustment unit and the first curvature adjustment unit 500A.

The protrusions 540c and 540d include a first protrusion 540c and a second protrusion 540d like the first curvature adjustment unit 500A.

The first protrusion 540c is formed to protrude near a lower edge of the rear surface of the screen unit 200. In the exemplary embodiment, the first protrusion 540c is formed in a lower left edge of the rear surface of the screen unit 200. Thus, the first protrusion 540c is disposed to be spaced apart from the first protrusion 540a of the first curvature adjustment unit 500A in the vertical direction of the screen unit 200. Here, the first protrusion 540c of the second curvature adjustment unit 500B is disposed on the same vertical line as the first protrusion 540a of the first curvature adjustment unit 500A.

The second protrusion 540d is formed in a lower right edge of the rear surface 202 of the screen unit 200. Thus, the second protrusion 540d is disposed to be spaced apart from the second protrusion 540b of the first curvature adjustment unit 500A in the vertical direction of the screen unit 200. Here, the second protrusion 540d of the second curvature adjustment unit 500b is disposed on the same vertical line as the second protrusion 540b of the first curvature adjustment unit 500A.

Therefore, the first protrusion 540a of the first curvature adjustment unit 500A, the second protrusion 540b of the first curvature adjustment unit 500A, the first protrusion 540c of the second curvature adjustment unit 500B, and the second protrusion 540d of the second curvature adjustment unit 500B are disposed in a rectangular form.

The supporting plate 520b is disposed in a lower portion of the screen unit 200 to be spaced apart from the supporting plate 520a of the first curvature adjustment unit 500A. Further, the supporting plate 520b of the second curvature adjustment unit 500B includes a vertical portion 522b, a first horizontal portion 524b, and a second horizontal portion 526b like the supporting plate 520a of the first curvature adjustment unit 500A.

A pair of mounting grooves 580a and 580b are formed in the second horizontal portion 526b to combine the second horizontal portion 526b with the mounting bracket 360. A pair of mounting units 362 and 364, which are mounted on the pair of grooves 580a and 580b, respectively, are formed in the mounting bracket 360. The pair of mounting units 362 and 364 have a protruding plate shape and are mounted on the mounting grooves 580a and 580b of the second horizontal portion 526b, respectively.

The mounting bracket 360 supports the screen unit 200 through coupling between the mounting units 362 and 364 and the second horizontal portion 526b. Further, the mounting bracket 360 may be directly mounted on the rear surface 202 of the screen unit 200 in an adhesion manner to support the screen unit 200.

The fasteners 560c and 560d are referred to as a first fastener 560c and a second fastener 560d, respectively.

The first fastener 560c and the second fastener 560d are screw-combined with the first protrusion 540c and the second first protrusion 540d, respectively. The first fastener 560c and the second fastener 560d may be rotated in a clockwise direction or in a counterclockwise direction, respectively to cause the first protrusion 540c and the second protrusion 540d to move in a forward and backward direction. Thus, both lower edges of the screen unit 200 fixed to the first protrusion 540c and the second protrusion 540d may move in the forward and backward direction.

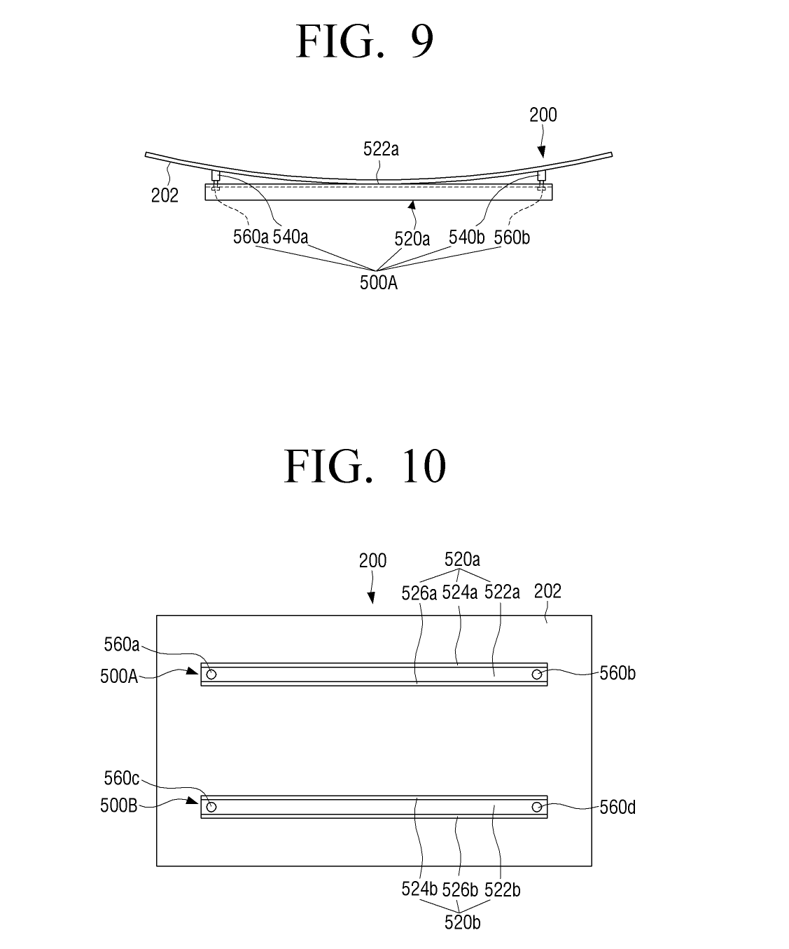

FIGS. 9 and 10 are views illustrating a curvature adjustment unit provided in the screen unit of FIG. 3.

Referring to FIG. 9, a central portion of the vertical portion 522a of the supporting plate 520a of the first curvature adjustment unit 500A is in contact with and supports the rear surface 202 of the screen unit 200. Since the central portion of the rear surface 202 of the screen unit 200 is in contact with and supported by the vertical portion 522a, when the curvature of the screen unit 200 is adjusted through the curvature adjustment unit 500, both edges of the screen unit 200 may move in the forward and backward direction on the basis of the central portion of the screen unit 200 as illustrated in FIG. 13.

Referring to FIG. 10, as described above, the first curvature adjustment unit 500A and the second curvature adjustment unit 500B are disposed parallel to each other in the vertical direction of the screen unit 200. Further, the first fastener 560a of the first curvature adjustment unit 500A, the second fastener 560b of the first curvature adjustment unit 500A, the first fastener 560c of the second curvature adjustment unit 500B, and the second fastener 560d of the second curvature adjustment unit 500B are disposed in a rectangular form.

FIG. 11 is a view illustrating mounting of a curvature adjustment unit on the screen unit of FIG. 3.

Referring to FIG. 11, the coupling of the first curvature adjustment unit 500A with the screen unit 200 may be performed by sequentially disposing the supporting plate 520a to face the first protrusion 540a and the second protrusion 540b and combining the first fastener 560a and the second fastener 560b with the first protrusion 540a and the second protrusion 540b through the first through hole 523a and the second through hole 523b of the supporting plate 520a, respectively. Here, the central portion of the vertical portion 522a in the supporting plate 520a is in contact with and supports to the rear surface 202 of the screen unit 202 as described in FIG. 10.

The coupling of the second curvature adjustment unit 500B with the screen unit 200 may be performed by sequentially disposing the supporting plate 520b to face the first protrusion 540c and the second protrusion 540d and combining the first fastener 560c and the second fastener 560d with the first protrusion 540c and the second protrusion 540d through the first through hole 523c and the second through hole 523d of the supporting plate 520b, respectively. Here, the central portion of the vertical portion 522b in the supporting plate 520b is in contact with and supports to the rear surface 202 of the screen unit 202 like the supporting plate 520a of the first curvature adjustment unit 500A.

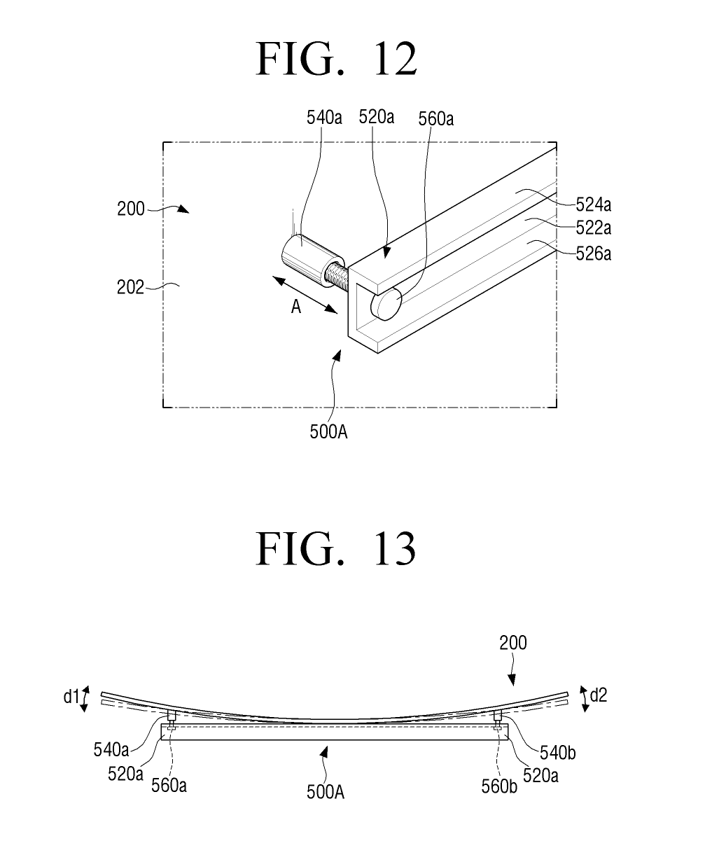

FIGS. 12 and 13 are views illustrating curvature adjustment of a screen unit through the curvature adjustment unit of FIG. 11.

Distortion may occur in image displayed in the projection apparatus (10 of FIG. 1) due to installation places or curvature deviation of the screen unit 200. As described above, the curvature adjustment unit (500 of FIG. 8) may adjust the curvature of the screen unit 200 to prevent the image distortion.

Referring to FIG. 12, the user rotates the first fastener 560a of the first curvature adjustment unit 500A in a clockwise direction or a counterclockwise direction to cause the first protrusion 540a to move in a forward and backward direction A. According to moving of the first protrusion 540a, the screen unit 200 may also move in the forward and backward direction. FIG. 12 illustrates the curvature adjustment unit (500 of FIG. 8) disposed near upper left edge of the screen unit 200.

Although not shown, the projection apparatus (10 of FIG. 1) may also rotate the second fastener 560b of the first curvature adjustment unit 500A, the first fastener 560c of the second curvature adjustment unit 500B, and the second fastener 560d of the second curvature adjustment unit 500B in the clockwise direction or a counterclockwise direction to cause the second protrusion 540b of the first curvature adjustment unit 500A, the first protrusion 540c of the second curvature adjustment unit 500B, and the second protrusion 540d of the second curvature adjustment unit 500B to move in the forward and backward direction.

Referring to FIG. 13, the upper left edge of the screen unit 200 moves in the forward and backward direction d1 through rotation of the first fastener 560a of the first curvature adjustment unit 500A in the clockwise direction or the counterclockwise direction and the upper right edge of the screen unit 200 moves in the forward and backward direction d2 through the rotation of the second fastener 560b of the first curvature adjustment 500A in the clockwise direction or in the counterclockwise direction.

Although not shown, the lower left edge and the lower right edge of the screen unit 200 move in the forward and backward direction through rotations of the first fastener 560c and the second fastener 560d of the second curvature adjustment unit (500B of FIG. 8) in the clockwise direction or in the counterclockwise direction.

Thus, the projection unit (10 of FIG. 1) may independently adjust forward and backward positions of the screen unit 200 in four directions of four edge of the upper left edge, the upper right edge, the lower left edge, and the lower right edge of the screen unit 200.

Therefore, when the user watches an image displayed in the projection apparatus 10, if the distortion of the image occurs in a specific portion of the screen, among the first fastener 560a and the second faster 560b of the first curvature adjustment unit 500A and the first fastener 560c and the second fastener 560d of the second curvature adjustment unit 500B, the user rotates a fastener corresponding to the specific portion in which the distortion occurs in the clockwise direction or in the counterclockwise direction and adjusts the curvature of the screen unit 200 in the specific portion in which the distortion occurs so that the distortion of the image may be removed.

The foregoing exemplary embodiments and advantages are merely exemplary and are not to be construed as limiting the present inventive concept. The exemplary embodiments can be readily applied to other types of devices. Also, the description of the exemplary embodiments is intended to be illustrative, and not to limit the scope of the claims, and many alternatives, modifications, and variations will be apparent to those skilled in the art.

What is claimed is:

1. A projection apparatus, comprising:
an image projector configured to form an image and project the formed image;
a screen unit configured to display the image projected from the image projector; and
a mounting unit on which the image projector and the screen unit are mounted,
wherein the screen unit is formed to have a curvature.

2. The projection apparatus as claimed in claim 1, wherein the screen unit includes:
a screen configured to display the image; and
a screen attaching part to which the screen is attached and which is formed to be concavely curved at a side thereof to which the screen is attached.

3. The projection apparatus as claimed in claim 2, wherein the screen is attached to the screen attaching part via lamination.

4. The projection apparatus as claimed in claim 2, wherein the screen attaching part includes:
a front plate to which the screen is attached;
a rear plate disposed in a rear of the front plate; and
a strength reinforcing member disposed between the front plate and the rear plate.

5. The projection apparatus as claimed in claim 4, wherein the strength reinforcing member has a honeycomb shape.

6. The projection apparatus as claimed in claim 4, wherein the strength reinforcing member has a wave shape.

7. The projection apparatus as claimed in claim 4, wherein the strength reinforcing member is formed so that a plurality of grooves are continuously formed to be spaced apart from each other at least one from among horizontally and vertically.

8. The projection apparatus as claimed in claim 4, further comprising at least one curvature adjuster disposed in rear of the screen unit and configured to adjust the curvature of the screen unit.

9. The projection apparatus as claimed in claim 8, wherein the curvature adjuster is included in pairs and the pair of curvature adjusters are disposed to be spaced apart from each other in a vertical direction of the rear plate.

10. The projection apparatus as claimed in claim 8, wherein the curvature adjuster includes:
at least one protrusion formed to protrude from the rear plate;
a supporting plate formed along a length direction of the rear plate and disposed to face the at least one protrusion; and
at least one fastener configured to pass through the supporting plate and be fastened to the at least one protrusion so that the at least one protrusion moves in a forward and backward direction.

11. The projection apparatus as claimed in claim 10, wherein the at least one protrusion is included in pairs and the pair of protrusions are disposed to be spaced apart from each other in the length direction of the rear plate.

12. The projection apparatus as claimed in claim 10, wherein the at least one protrusion and the at least one fastener are screw-combined.

13. The projection apparatus as claimed in claim 10, wherein the supporting plate includes:
a vertical portion which faces the at least one protrusion and in which at least one through hole, through which the at least one fastener passes, is formed;
a first horizontal portion extending from an end of the vertical portion; and
a second horizontal portion extending from the other end of the vertical portion.

14. The projection apparatus as claimed in claim 13, wherein the vertical portion is formed so that a central portion of a side surface of the vertical portion facing a rear surface of the rear plate is in contact with the rear surface of the rear plate.

15. The projection apparatus as claimed in claim 13, wherein the curvature adjuster is mounted on the mounting unit.

16. The projection apparatus as claimed in claim 15, wherein the mounting unit comprises:
a base frame;
a mounting bracket provided inside the base frame and on which the image projector and the screen unit are mounted; and
a cover frame which covers the base frame.

17. The projection apparatus as claimed in claim 16, wherein the mounting bracket includes at least mounting part mounted on the curvature adjuster.

18. The projection apparatus as claimed in claim 17, wherein the second horizontal portion includes at least one mounting groove via which the at least one mounting part is mounted.

19. The projection apparatus as claimed in claim 16, wherein the cover frame includes a cover glass through which the image projected from the image projector passes.

20. The projection apparatus as claimed in claim 1, wherein the image projector and the screen unit are integrally mounted.
